(19) United States
(12) Patent Application Publication
(10) Pub. No.: US 2013/0272564 A1
(43) Pub. Date: Oct. 17, 2013

(54) RECEIVER WITH A NON-UNIFORM SHAPED HOUSING

(71) Applicant: KNOWLES ELECTRONICS, LLC, Itasca, IL (US)

(72) Inventor: Thomas E. Miller, Arlington Heights, IL (US)

(21) Appl. No.: 13/783,970

(22) Filed: Mar. 4, 2013

Related U.S. Application Data
(60) Provisional application No. 61/611,633, filed on Mar. 16, 2012.
(60) Provisional application No. 61/611,656, filed on Mar. 16, 2012.

(51) Int. Cl. H04R 3/00

(52) U.S. Cl. CPC H04R 3/00
USPC 381/412

(57) ABSTRACT

A balanced armature receiver includes a magnet, a coil, and a housing. The magnet and the coil are disposed within the housing and the housing comprising a bottom surface. The bottom surface includes a first bottom portion with a first dimension and a second bottom portion with a second dimension. The bottom surface further includes a stepped portion that is integrally formed with and connects the first bottom portion and the second bottom portion. The first dimension is greater than the second dimension. A second base of the second bottom portion is coupled to the magnet. The second base is adjacent to a first base formed in the first bottom portion allowing the coil to extend through a plane where the magnet and the second base meet.

### CROSS REFERENCES TO RELATED APPLICATIONS

This patent claims benefit under 35 U.S.C. §119 (e) to U.S. Provisional Application No. 61/611633 entitled “A Receiver with Non-uniform Housing” filed Mar. 16, 2012, having attorney docket number 101415, and naming Thomas Miller as inventor, the content of which is incorporated herein by reference in its entirety.

This patent claims benefit under 35 U.S.C. §119 (e) to U.S. Provisional Application No. 61/611656 entitled “An Acoustic Apparatus with Adjustable Armature Position and Method for Positioning an Armature therein,” filed Mar. 16, 2012, having attorney docket number 101416, and naming Thomas Miller as inventor, the content of which is incorporated herein by reference in its entirety.

### TECHNICAL FIELD

This application relates to the construction of acoustic assemblies and, more specifically to the components of assemblies that are used to form a magnetic path in these assemblies.

### BACKGROUND OF THE INVENTION

Various types of microphones and receivers have been used through the years. In these devices, different electrical components are housed together within a housing or assembly. Other types of acoustic devices may include other types of components. These devices may be used in hearing instruments such as hearing aids or in other electronic devices such as cellular phones and computers.

The receiver motor typically includes a coil, a yoke, an armature (or reed), and magnets. An electrical signal applied to the coil and creates a magnetic field within the motor which causes the armature to move. Movement of the armature causes movement of a diaphragm, which creates sound. Together, the magnets, armature, and yoke form a magnetic circuit. The yoke may also serve to hold or support the magnets or other components.

In today's marketplace, smaller and lighter devices are often desired. For example, smaller receivers are often desired in many applications such as hearing aids. Unfortunately, with the use of the above-mentioned components it is difficult to reduce the size of a receiver beyond a certain limit.

Attempts have been made to eliminate, for example, the magnetic yoke and combine its functions with the housing. One problem with doing this is that the position of the magnet cannot be determined independently from the housing dimensions. This shortcoming typically forces the designer to use either very small coils or very large magnets, neither of which results in optimum performance.

Another previous attempted solution to the above-mentioned problems was to place a metal shim under the magnet, using a material for the shim that had soft magnetic properties. However, this attempted solution introduces opportunities for variation in magnet position, which must be tightly controlled for good acoustic performance. This previous approach also introduces additional steps in the manufacturing process and additional piece parts, thereby increasing the costs of producing the transducer.

### BRIEF DESCRIPTION OF THE DRAWINGS

For a more complete understanding of the disclosure, reference should be made to the following detailed description and accompanying drawings wherein:

FIG. 1 comprises a cross-sectional view of a transducer with a step-shaped housing according to various embodiments of the present invention;

FIG. 2 comprises a perspective exploded view of the transducer of FIG. 1 showing with an L-shaped armature according to various embodiments of the present invention;

FIG. 3 comprises a side view of the transducer of FIG. 1 and FIG. 2 showing a viewing window according to various embodiments of the present invention;

FIG. 4 comprises a perspective view of the transducer of FIGS. 1-3 with the armature connected to the outside of the transducer housing according to various embodiments of the present invention;

FIG. 5 comprises a perspective view of an alternative transducer with the armature connected to the inside of the transducer housing according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In the approaches described herein, the size of a receiver can be significantly reduced by combining the functions of a magnetic yoke and the receiver housing into one part or element. More specifically, the housing of the receiver is formed with a stepped portion that allows freedom in positioning the magnets of the receiver. Additionally and advantageously, using a non-flat base for the receiver housing eliminates the need for a piece part that could be required to raise the magnets away from the floor of the housing, does not require the use of large magnets, and allows for the use of adequately-sized (i.e., larger) coils. Consequently, the size of the receiver can be significantly decreased.

In many of these embodiments, a balanced armature receiver is provided that includes a magnet, a coil, and a housing. The housing has a bottom surface including a first bottom portion with a first diameter/width (or dimension) and a second bottom portion with a second diameter/width (or dimension). The first diameter is greater than the second diameter and a stepped portion provides a transitional region between the two bottom portions.

The base of the second bottom portion is coupled to the magnet and the base of the first bottom portion is coupled to the coil (to provide a magnetic mounting surface). The base of the second bottom portion is adjacent to the base of the first bottom portion and this positioning allows the coil to extend through a plane formed where the magnet and the base of the second bottom portion meet. The stepped design of the housing allows the magnets to be positioned properly to form a magnetic circuit and this is accomplished without the use of any additional part (e.g., a yoke) that would raise or hold the magnets. The deployment of large magnets is also avoided.

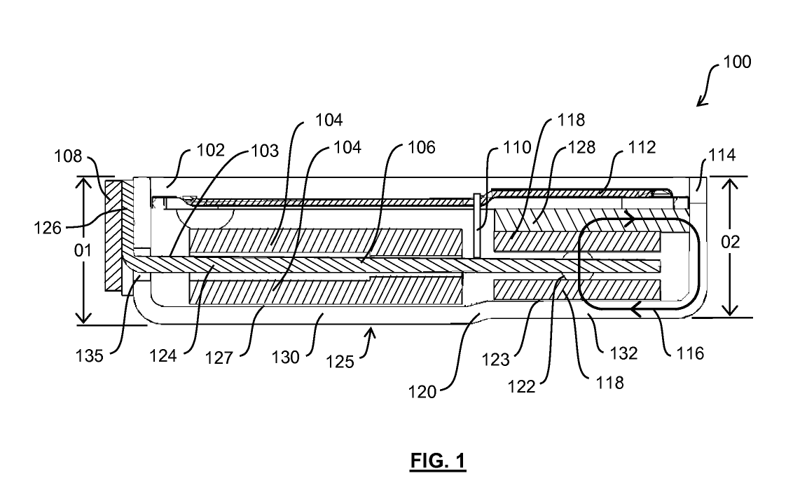

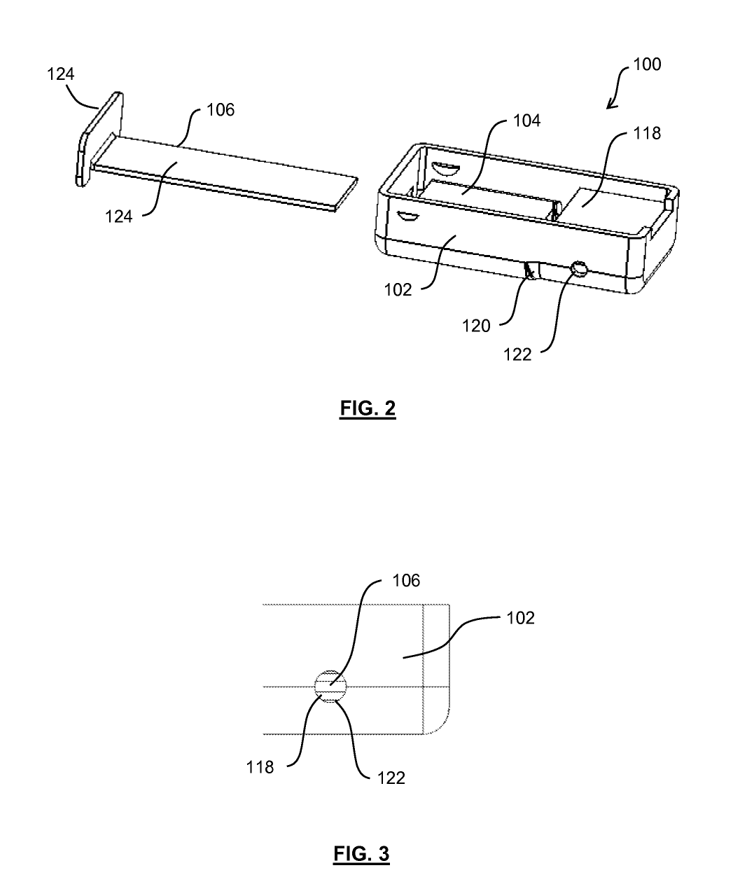

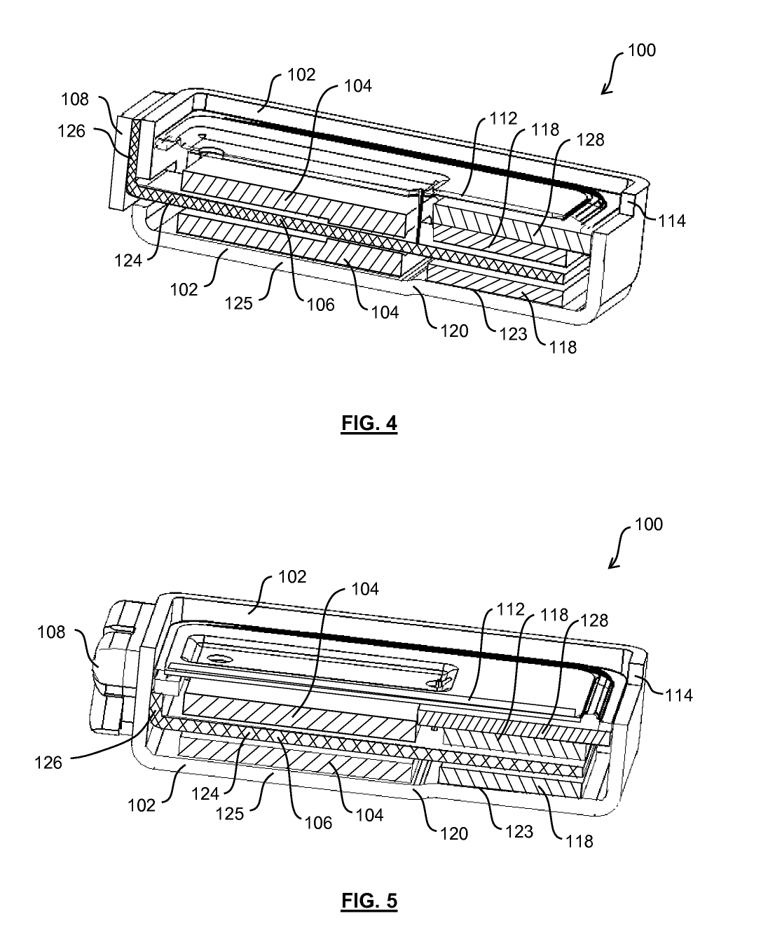

Referring now to FIGS. 1-4, one example of a transducer 100 with a stepped-shape housing is described. The transducer 100 includes a housing 102. The base 125 of the housing 102 is not flat, and includes a stepped portion 120 that transitions between a first portion 130 (with a diameter or dimension D1) and a second portion 132 (with a diameter or dimension D2). D1 is larger than D2. In one example, D1 is 2.7 mm and D2 is 1.7 mm. Other examples of dimensions are possible.

An armature or reed 106 (including an elongated or long section 124 and a shorter portion or section 126) extends through an opening or tunnel 103 in a coil 104 and is disposed between magnets 118. A rod 110 is attached to the armature 106 and to a diaphragm 112. Excitement of the coil 104 by an electrical signal received at a terminal 108 creates a magnetic flux that when combined with the flux from the magnets (path 116) moves the armature 106. Movement of the armature 106 causes the rod 110 to move and this in turn moves the diaphragm 112. Movement of the diaphragm 112 causes sound to be created and this exits the device 100 through an opening 114. In these figures, no cover is shown as this unit may be paired with a second device of the same construction. A support member 128 (e.g., made of a soft magnetic material) determines a position of the magnets 118 and provides the path 116.

The portion 126 of the armature 106 is coupled to the exterior of the housing 125 and extends through an opening 135 in the housing. A window 122 allows a user to observe the positioning of the armature 106 relative to the magnets 118 to ensure the positioning of these elements is correct.

A base 123 of the second portion 132 of the housing base 125 is coupled to the magnet 118. The base 123 of the second portion 132 is adjacent to a base (coil mounting surface) 127 of the bottom portion 130 of the housing base 125 and this positioning allows the coil 104 to extend through a plane formed where the magnet 118 and the base 123 of the second portion 132 meet. The narrowed dimensions of the housing 102 allow the magnets 118 to be positioned properly to form an optimum magnetic circuit and this is accomplished without the use of any additional part (e.g., a yoke) that would raise or hold the magnets 118. The deployment of large magnets is also avoided.

It will be appreciated that while a stepped-shaped portion 120 has a specific configuration and relative dimensions that have been described herein, other configurations, shapes, and relative dimensions are possible. For example, while the stepped portion 120 is smooth in its transition between adjacent portions, a more jagged transitional region (with several intermediate steps) may also be used. Other examples are possible.

Referring now to FIG. 5, an alternative example of a transducer is described. The transducer of FIG. 5 is the same as that of FIGS. 1-4 except that the portion 126 of the armature 106 is coupled to the interior of the housing 102 rather than extending through an opening in the housing 102 and being coupled to the exterior of the housing 102. The operation of the transducer 100 is the same as that described with respect to the operation of the transducer of FIGS. 1-4.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A balanced armature receiver, the receiver comprising:
a magnet;
a coil;
a housing, the magnet and the coil disposed within the housing and the housing comprising a bottom surface, and
wherein the bottom surface includes a first bottom portion with a first dimension and a second bottom portion with a second dimension, the bottom surface further including a stepped portion that is integrally formed with and connects the first bottom portion and the second bottom portion, the first dimension being greater than the second dimension;
wherein a second base of the second bottom portion is coupled to the magnet;
such that the second base is adjacent to a first base formed in the first bottom portion allowing the coil to extend through a plane where the magnet and the second base meet.

2. The balanced armature receiver of claim 1 wherein the second base directly supports the magnet.

3. The balanced armature receiver of claim 1 further comprising a tunnel that extends through the coil and the magnet, and wherein an armature that extends through the tunnel.

4. The balanced armature receiver of claim 3 wherein the armature extends through an opening in the housing.

5. The balanced armature receiver of claim 3 wherein the armature is coupled to the interior of the housing.

6. The balanced armature receiver of claim 3 further comprising a rod that is coupled to the armature.

7. The balanced armature receiver of claim 6 further comprising a diaphragm that coupled to the rod.

8. The balanced armature receiver of claim 1 further comprising a window, the window formed through the housing and arranged to allow a user to view a position of the armature.
